(19) United States
(12) Patent Application Publication
(10) Pub. No.: US 2017/0124259 A1
(43) Pub. Date: May 4, 2017

(54) COMPUTER PROGRAM PRODUCT, SYSTEM AND METHOD FOR PROVIDING AN EMERGENCY AID SERVICE AND PERSONALIZED MANAGEMENT OF HEALTH RECORDS

(71) Applicant: EmpowerM Mobility Solutions Pvt Ltd, HYDERABAD (IN)

(72) Inventors: Umashankar Kotturu, HYDERABAD (IN); Jagadish Babu Vishwanatham, HYDERABAD (IN)

(21) Appl. No.: 15/129,506

(22) PCT Filed: Mar. 30, 2015
(86) PCT No.: PCT/IB2015/052323

§ 371 Date: Sep. 27, 2016

(30) Foreign Application Priority Data
Apr. 1, 2014 (IN) 1758/CHE/2014

(51) Int. Cl. G06F 19/00

(52) U.S. Cl. CPC G06F 19/322; G06F 19/327; G06F 19/3418

(57) ABSTRACT

Exemplary embodiment of the present disclosure is directed towards to a computer program product, system and method for providing an emergency aid service and personal management of health records. The system includes one or more user authenticated data communication devices integrated with an application platform triggered by an external triggering unit for transmitting the emergency of the registered user to one or more emergency aid service providers and one or more personal care aids provided by the registered user. The computer program product enabled by a triggering unit configured to select an emergency from a list of predetermined emergency aid service providers, track the current geographical location of the registered user, instantly track the medical record of the registered user and notify the invoked emergency aid service provider and the one or more personal care aids.

### TECHNICAL FIELD

The present disclosure generally relates to a field of providing emergency services. More particularly, the present disclosure generally relates to a computer program product, system and method for providing an emergency aid service and personalized management of health records.

### BACKGROUND

In a health emergency two aspects play critical role, i.e., time taken in getting medical attention to the patient and the other is providing effective care to the patient by the emergency providers. In most cases, in any emergency, the person in distress does not have a specific number to call for help due to lack of preparedness and awareness. Also since there is no single repository of all addresses integrated into any of the maps services it is very difficult for the emergency service providers to find the specific location of the person in distress and hence takes considerable time for the person in distress to explain the location to which help need to be provided.

Presently, the emergency responders do not have a background of the current/past health information of the person in distress and do not know the cause of the emergency in advance, which would be helpful in reducing the time spent to understand the problem. Thus, due to the lack of the above information (past health history and the current problem), the emergency responders cannot make an educated choice on the right hospital to take the patient to. Besides the emergency responders do not have a way to seamlessly notify the hospital to which the patient is being taken to, so that doctors would be prepared for providing immediate responses. The doctors responding to the emergency do not have access to the patient's regular doctors/hospitals/clinic, this results in the inability of the doctor handling the emergency to call the previous doctors to better understand the patient health history. Also the patient in emergency or distress cannot inform multiple people (friends/near dear ones) about the distress and also about his/her current location. Even if they are informed about his/her condition they are not updated about further actions during the emergency.

In the light of aforementioned discussion there exists a need of a computer program product, system and method for providing emergency aid services and that may be simultaneously used for management of health records.

### BRIEF SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A more complete appreciation of the present disclosure and the scope thereof can be obtained from the accompanying drawings which are briefly summarized below and the following detailed description of the presently preferred embodiments.

An exemplary preferred aspect is to instantly build empathy with plurality of emergency users of similar health profile over an anonymous group for receiving expert opinion from various emergency aid service providers.

Another exemplary preferred aspect is to maintain registered user data in a local data repository unit and with the emergency aid service providers.

Also another exemplary preferred aspect is to manage health record and share the emergency medical record with the multiple emergency aid service providers based on the emergency of the registered user.

Further another exemplary preferred aspect is to build online services, manage appointments, promote services, manage registrations and manage referrals corresponding to the multiple emergency aid service providers.

Still another exemplary preferred aspect is to use the computer program product in emergency of registered users, private setup or standalone for organizations, ability to license and point solutions for congregations.

Exemplary embodiment of the present disclosure is directed towards a computer program product for providing an emergency aid service. According to a first aspect, the computer program product includes an emergency selecting unit configured to select at least one emergency from a predetermined list of emergencies or to auto detect and initiate an emergency using one of the monitoring devices. The emergency selecting unit configured to be invoked by a registered user in an emergency or by one or more personal care aids of the registered users or auto triggered by one of the monitoring devices.

According to the first aspect, the computer program product includes a location tracking unit configured to dynamically track a current geographical location of the registered users invoking the emergency. The tracked geographical location transmitted to the one or more emergency aid service providers based on the emergency invoked by the registered users; and the one or more personal care aids present at the specified geographical location.

According to the first aspect, the computer program product includes an emergency medical record managing unit configured to instantly track medical record corresponding to the registered user for providing a comprehensive view of the record in any emergency. The tracked data transmitted to the one or more emergency aid service providers and the one or more personal care aids.

According to the first aspect, the computer program product includes a profile management and personalizing unit configured to store a set of personalized profiles corresponding to the registered user, a set of personalized profiles corresponding to the registered emergency aid service providers; a set of emergencies and medical records corresponding to the registered user. The access of medical records corresponding to the emergency user is enabled for the emergency aid service providers only for the duration of the emergency.

According to the first aspect, the computer program product includes notification and alerting unit configured to notify the one or more emergency aid service providers; and the one or more personal care aids regarding the emergency of the registered user in a specified geographical location along with the tracked medical record of the registered user through a data communication network.

According to the first aspect, the computer program product includes an instant messaging unit configured for enabling the registered user to instantly communicate with the one or more emergency aid service providers for receiving plurality of opinions related to the queries requested by the registered user.

According to the first aspect, the computer program product includes a local data repository unit configured to store set of personal care aids provided by the registered user, set of emergency aid services, medical record of the one or more users and habits of the personal care aids corresponding to the registered user.

According to a second aspect, a system for providing an emergency aid service is disclosed. The system includes one or more users registered with a unique identification code configured to communicate in an emergency for receiving plurality of predefined emergency aid services.

According to the second aspect, the system includes an external triggering unit in communication with the one or more registered users configured to trigger an application platform integrated within the one or more registered users. The application platform includes an emergency selecting unit configured to select at least one emergency from a predetermined list of emergencies. The emergency selecting unit configured to be invoked by a registered user in an emergency and by one or more personal care aids of the registered users.

According to the second aspect, the system including an application platform includes a location tracking unit configured to dynamically track a current geographical location of the registered users invoking the emergency. The tracked geographical location transmitted to the one or more emergency aid service providers based on the emergency invoked by the registered users and to the one or more personal care aids.

According to the second aspect, the system including an application platform includes an emergency medical record managing unit configured to instantly track emergency medical record corresponding to the registered user for providing an instantaneous view of the emergency medical record in any emergency. The tracked data transmitted to the one or more emergency aid service providers and the one or more personal care aids.

In order for the emergency aid service providers to be able to see the detailed information about the person in emergency automatically when they receive the phone call, the emergency dial out may be delayed by 20 seconds.

According to the second aspect, the system including an application platform includes a profile management and personalizing unit configured to store a set of personalized profiles corresponding to the registered user, a set of personalized profiles corresponding to the registered emergency aid service providers, a set of emergencies and medical records corresponding to the registered user.

According to the second aspect, the system including an application platform includes notification and alerting unit configured to notify the one or more emergency aid service providers and the one or more personal care aids regarding the emergency of the registered user in a specified geographical location along with the tracked medical record of the registered user through a data communication network.

According to the second aspect, the system including an application platform includes an instant messaging unit configured for enabling the registered user to instantly communicate with the one or more emergency aid service providers for receiving plurality of opinions related to the queries requested by the registered user.

According to the second aspect, the system including an application platform includes a local data repository unit configured to store set of personal care aids provided by the registered user, set of emergency aid services, medical record of the one or more users and habits corresponding to the personal care aids of the registered user.

According to the second aspect, the system includes a remote data repository unit in communication with the application platform integrated within one or more user data communication devices corresponding to the one or more users configured to store the data received from the one or more registered users.

According to the second aspect, the system includes one or more emergency aid service providers registered with the application platform enabled by the registered one or more users for providing predefined services required by the corresponding registered one or more users.

According to the second aspect, the system includes one or more personal care aids provided by the each individual registered one or more users enabled for notifying the emergency corresponding to the registered one or more users.

According to a third aspect, a method for providing an emergency aid service. According to the third aspect, the method includes providing a unique identification code to one or more registered users for communicating in an emergency to receive plurality of predefined emergency aid services.

According to the third aspect, the method includes triggering an application platform integrated within the one or more registered user authenticated data communication devices by an external triggering unit in communication with the one or more registered users. The application platform includes selecting at least one emergency from a predetermined list of emergencies by an emergency selecting unit. The emergency selecting unit configured to be invoked by a registered user in an emergency and by one or more personal care aids of the registered users.

According to the third aspect, the method including the application platform includes dynamically tracking a current geographical location of the registered users invoking the emergency by a location tracking unit. The tracked geographical location transmitted to the one or more emergency aid service providers based on the emergency invoked by the registered users and to the one or more personal care aids.

According to the third aspect, the method including the application platform includes instantly tracking a medical record corresponding to the registered user by an emergency medical record managing unit for providing a comprehensive view of the record in any emergency. The tracked data transmitted to the one or more emergency aid service providers and the one or more personal care aids.

According to the third aspect, the method including the application platform includes storing a set of personalized profiles corresponding to the registered user, a set of personalized profiles corresponding to the registered emergency aid service providers, a set of emergencies and medical records corresponding to the registered user by a profile management and personalizing unit.

According to the third aspect, the method including the application platform includes notifying the one or more emergency aid service providers and the one or more personal care aids regarding the emergency of the registered user in a specified geographical location along with the tracked medical record of the registered user by a notification and alerting unit through a data communication network.

According to the third aspect, the method including the application platform includes enabling the registered user to instantly communicate with the one or more emergency aid service providers by an instant messaging unit for receiving plurality of opinions related to the queries requested by the registered user.

According to the third aspect, the method including the application platform includes storing a set of personal care aids provided by the registered user, set of emergency aid services, medical record of the one or more users and habits corresponding to the personal care aids provided by the registered user in a local data repository unit.

According to the third aspect, the method includes storing data received from one or more registered users in a remote data repository unit in communication with the application platform integrated within the one or more user authenticated data communication devices.

According to the third aspect, the method includes enabling one or more emergency aid service providers registered with the application platform for providing predefined emergency aid services invoked by the corresponding registered one or more users.

According to the third aspect, the method includes enabling one or more personal care aids provided by each individual registered one or more users for notifying the emergency corresponding to the registered one or more users.

### BRIEF DESCRIPTION OF DRAWINGS

Other objects and advantages of the present invention will become apparent to those skilled in the art upon reading the following detailed description of the preferred embodiments, in conjunction with the accompanying drawings, wherein like reference numerals have been used to designate like elements, and wherein:

FIG. 1A is a block diagram illustrating an exemplary system for providing emergency aid service.

FIG. 1B is a block diagram illustrating another exemplary system for providing emergency aid service by enabling an application platform.

FIG. 1C is a diagram illustrating an exemplary application platform integrated in the authenticated data communication device.

FIG. 1D is a diagram illustrating another exemplary system for sharing data between multiple emergency aid service providers and personal care aids.

FIG. 1e is a diagram illustrating an example exemplary system for sharing data between multiple emergency aid service providers.

FIG. 2 is a flow diagram illustrating an exemplary method for providing an emergency aid service.

FIG. 3 is a flow diagram illustrating an exemplary method of invoking an emergency aid service provider by a registered user.

FIG. 4 is a flow diagram illustrating an exemplary method for enabling emergency aid service provider to communicate with the registered user.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

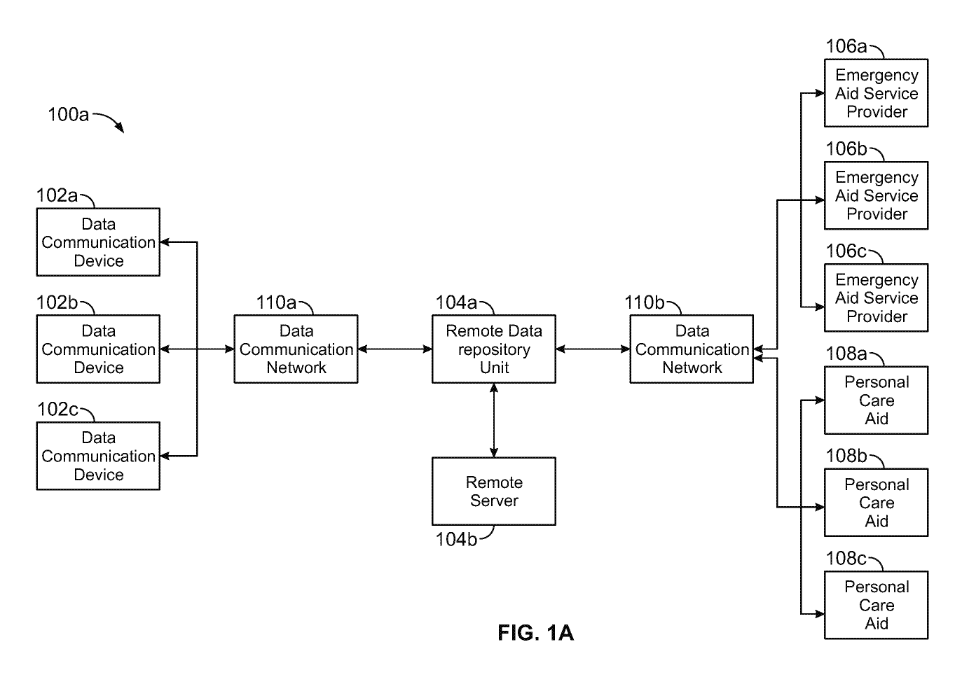

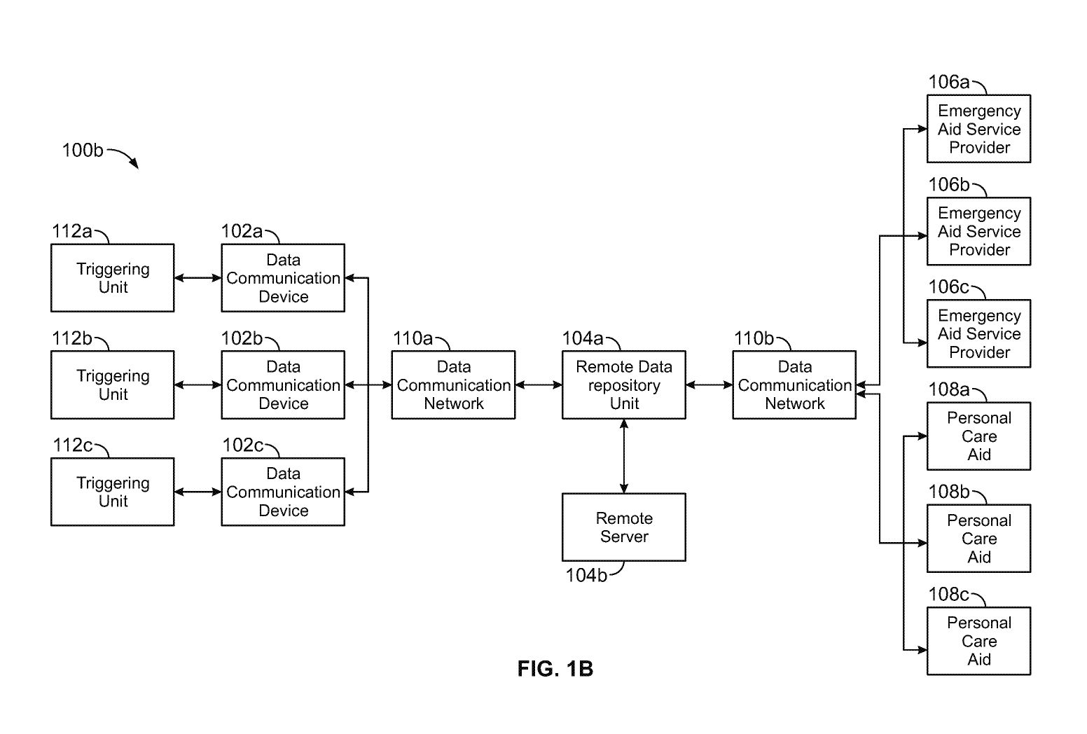

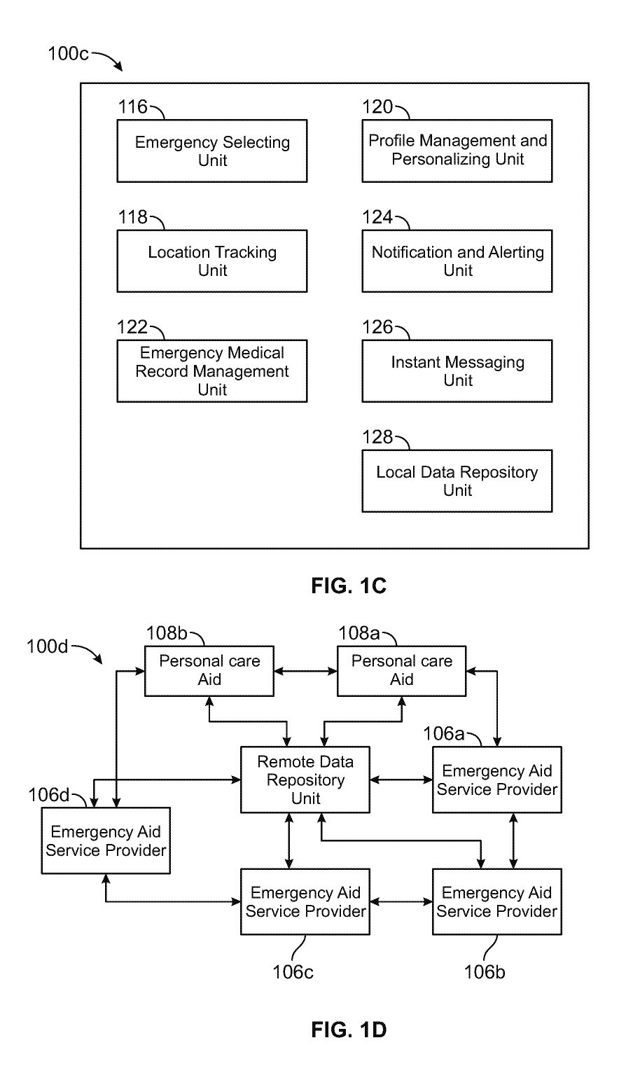

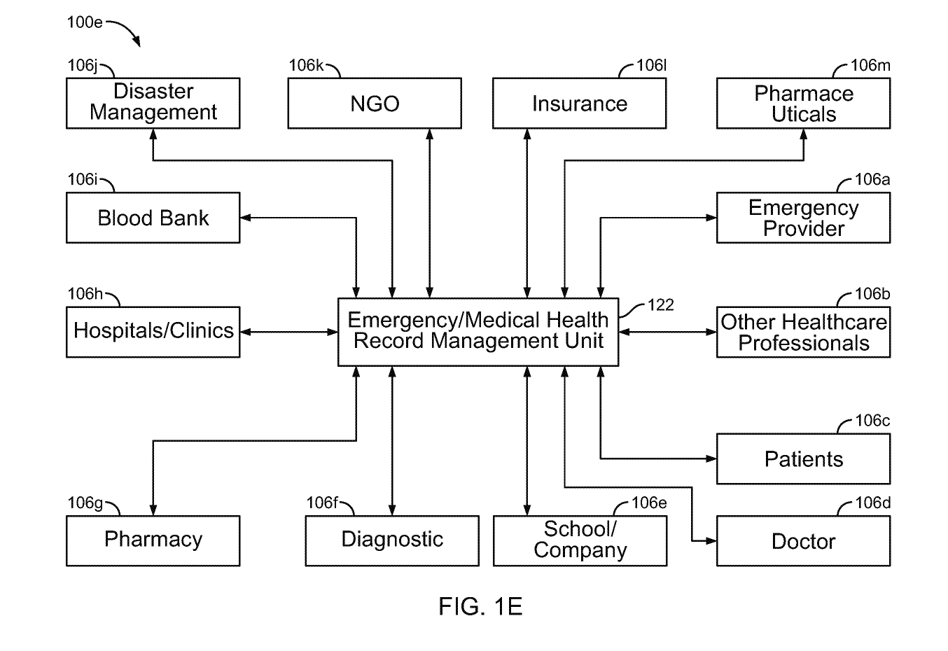

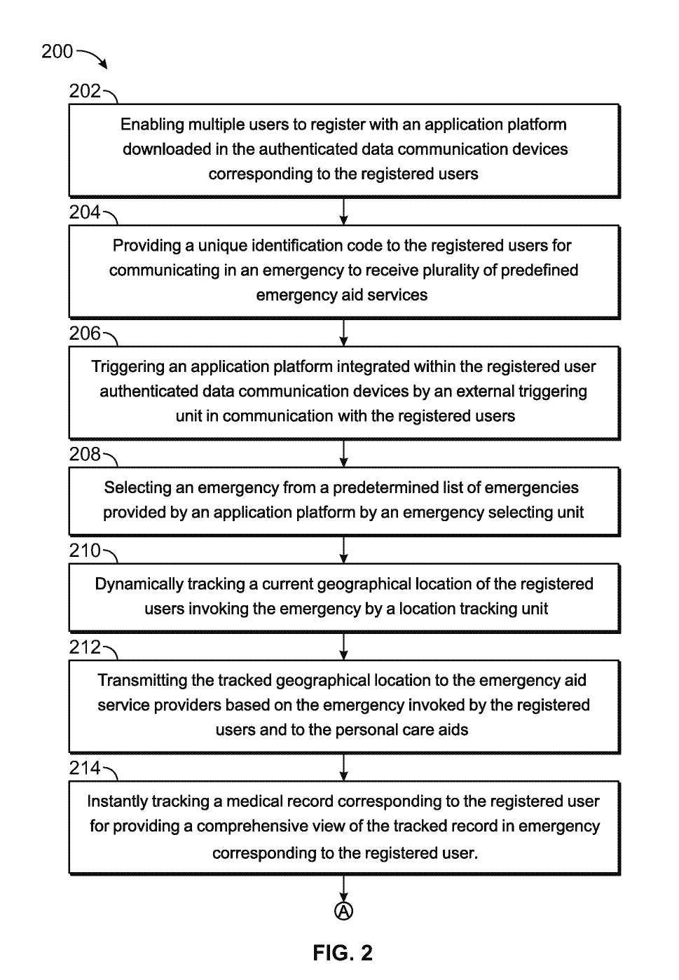

FIG. 1A is a block diagram 100a illustrating an exemplary system for providing an emergency aid service. According to a non limiting exemplary embodiment of the present disclosure, the system includes data communication devices 102a, 102b and 102c corresponding to multiple users registered with an application platform downloaded in the each individual data communication device 102a, 102b and 102c for communicating with multiple emergency aid service providers 106a, 106b and 106c in emergency. The data communication device 102a, 102b and 102c may include but not limited to a mobile phone, cellular phone, tablet, portable device, custom gadget, implanted devices, any wearable device and the like. For convenience the present disclosure discuss only about the three data communication devices 102a, 102b and 102c. However it should be understood that in general there may be any number of data communication devices as similar as the data communication devices 102a, 102b and 102c that may be included in the system. Therefore the present disclosed data communication device that may be included and/or supported by a system 100 consistent with the disclosed embodiments.

As shown in FIG. 1a, the data communication devices 102a, 102b and 102c registered with the application platform adds the multiple personal care aids 108a, 108b and 108c related corresponding to the user authenticated with the data communication devices 102a, 102b and 102c. The registration corresponding to the data communication device 102a, 102b and 102c with the application platform is authenticated through a password, biometric scanner, retina scanner and voice recognition and the like. The personal care aids added by the registered users may be father, mother, brother, friend or any other caregiver based on the interest of the each individual user. For convenience the present disclosure discuss only about the three personal care aids 108a, 108b and 108c. However it should be understood that in general there may be any number of personal care aids as similar as the personal care aids 108a, 108b and 108c that may be included in the system. Therefore the present disclosed personal care aids that may be included and/or supported by a user registered with the application platform consistent with the disclosed embodiments. Further the data collected by the data communication devices 102a, 102b and 102c are stored in a remote data repository unit 104a through a data communication network 110a and the data stored in the remote data repository unit 104a is further updated in a remote server 104b. The data provided by the registered user and the medical record corresponding to the registered user is encrypted to identify the health record corresponding to the specified registered user.

Also as shown in FIG. 1a, for example, the data communication device 102a corresponding to the user is in emergency at a specified geographical location enables the application platform for communicating with a specific emergency aid service provider 106a, 106b and 106c. For convenience the present disclosure discuss only about the three emergency aid service providers 106a, 106b and 106c. However it should be understood that in general there may be any number of emergency aid service providers as similar as the emergency aid service providers 106a, 106b and 106c that may be included in the system. Therefore the present disclosed emergency aid service providers that may be included and/or supported by a user registered with the application platform consistent with the disclosed embodiments. The emergency aid service provider 106a, 106b and 106c may include but not limited to an emergency management and research institute or 108 services, hospital, ambulance and the like. The enabled application platform tracks the current geographical location of the data communication device 102a for notifying corresponding emergency aid service provider 106a, 106b and 106c and any personal care aids 108a, 108b and 108c.

Further as shown in FIG. 1a, the tracked data corresponding to the registered user in emergency is stored in a remote data repository unit 104a through a data communication network 110a and the data stored in the remote data repository unit 104a is further updated in a remote server 104b. Also the corresponding emergency aid service providers 106a, 106b and 106c are able to fetch the data related to the corresponding user authenticated data communication device 102a and the medical record of the user through a data communication network 110b. Thus based on the data received by the respective emergency aid service provider 106a, 106b and 106c, the predefined service is provided to the corresponding user in emergency. Also the registered user authenticated data communication devices 102a, 102b and 102c are able to address various health queries and view appointments corresponding to the selected emergency aid service provider.

Also further as shown in FIG. 1a, the multiple emergency aid service providers 106a, 106b and 106c authenticated with corresponding data communication devices also register with an application platform for communicating with the registered users. The data communication devices 106a, 106b and 106c corresponding to the emergency aid service provider may include but not limited to a mobile, tablet, personal computer, custom gadget and the like. The each individual emergency aid service provider 106a, 106b and 106c is provided with a unique identification code on registering with the specified application platform. The registered emergency aid service provider 106a, 106b and 106c builds a user database for instantaneous view of the health record or for sharing the data to any other emergency aid service provider 106a, 106b and 106c in emergency of the registered user. Also the emergency aid service provider 106a, 106b and 106c are able to build an each individual registered user database in communication with the corresponding emergency aid service provider 106a, 106b and 106c, an online reputation, a unique network, manage appointments, manage referrals and leverage other emergency aid service providers knowledge. Further, for example, in some embodiments few of the emergency aid service providers 106a, 106b and 106c such as clinics, labs, pharmacies and the like are also used to build online presence, promote your services, build member subscription, manage appointments and manage registrations. In some embodiments, the emergency aid service providers 106a, 106b and 106c may be nongovernmental organizations enables health workers access, manage patient record and memberships.

FIG. 1B is a block diagram 100b illustrating another exemplary system for providing emergency aid service by enabling an application platform. According to a non limiting exemplary embodiment of the present disclosure, the system includes a triggering unit 112a, 112b and 112c in communication with the corresponding data communication devices 102a, 102b and 102c as mentioned in the above FIG. 1a. The triggering unit 112a, 112b and 112c may include but not limited to a biometric scans or monitors, accelerometer, heat sensor, water pressure sensor, Geofencing, global positioning system, compass, altimeter, gesture based, voice command based, special buttons, third party Bluetooth integration, photometric scans, sound frequency, air quality/chemical density, missed call and the like. For convenience the present disclosure discuss only about the three triggering units 112a, 112b and 112c. However it should be understood that in general there may be any number of triggering units as similar as the triggering units 112a, 112b and 112c that may be included in the system. Therefore the present disclosed triggering units that may be included and/or supported by a system 100b consistent with the disclosed embodiments.

As shown in FIG. 1b, the triggering unit 112a, 112b and 112c used to activate the corresponding application platform integrated within the data communication devices 102a, 102b and 102c in emergency through any communication protocols which may include but not limited to a short message service, web service, chat protocol, internet relay chat protocol, remote method invocation protocol, location based service and the like. The enabled application platform further dynamically tracks the current geographical location of the user in emergency and the complete medical record of the user to provide an instant service to the user. Further, in some embodiments, the application platform may be enabled by a user in emergency for communicating with corresponding emergency aid service providers 106a, 106b and 106c. In some other embodiments the application platform is also enabled by any personal care aid added by the user for communicating with the corresponding emergency aid service providers 106a, 106b and 106c.

FIG. 1C is a diagram 100c illustrating an exemplary application platform integrated in the authenticated data communication device. According to a non limiting exemplary embodiment of the present disclosure, the application platform 114 triggered by the registered user invokes an emergency selecting unit 116 for selecting a type of emergency from multiple emergencies may include but not limited to a health such as head injury/stroke, heart attack, accident, snake bite, pregnancy and like, police/security and fire service by a user in emergency or by any personal care aid added by the registered user. The invoked emergency aid service provider accesses the complete health records of the registered user and revokes the emergency to disable the access of the emergency aid service provider and other personal care aids. Thus the access of the medical records corresponding to the user is accessed only for a specific period of time, which would be enabled with emergency invoked by the user and disabled by revoking the emergency. The application platform 114 is also triggered to add a list of personal care aid members and build a complete profile over the platform.

As shown in FIG. 1c, the emergency invoked by the user will instantaneously initiate a call to the respective emergency aid service provider selected by the user in a predefined period of time, where in a predefined period of time, the application platform 114 transmits the data corresponding to the emergency user to the selected emergency aid service provider. Thus the prior data received by the emergency aid service provider would be impactful and helpful on having a conversation with a emergency user for getting aware of the emergency of the corresponding user. Also the electronic medical records and the complete health care ecosystem of the corresponding user is captured and integrated in the application platform 114 to maintain a entire history of the users ailments in the application platform 114. Further the data maintained in the application platform 114 can be shared with any emergency aid service provider 106a, 106b and 106c across the world for enhancing the effectiveness of care especially remote care.

As shown in FIG. 1c, the application platform 114 includes a location tracking unit 118 configured to dynamically track the current geographical location of the user in emergency through a global positioning system and notify the specified emergency aid service provider in the corresponding geographical location based on the selected type of emergency. Also, a profile management and personalizing unit 120 configured to store the personalized details of the registered users, personalized profile details of the user, health records corresponding to the user, subscribed doctors, subscribed organizations, contact information of the personalized care aids corresponding to the registered users and the insurance details. Also, the profile management and personalizing unit 120 configured to maintain a history of visits corresponding to the selected emergency aid service provider and also extends the health records corresponding to the registered user to multiple emergency aid service providers as required. The profile management and personalizing unit 120 also includes the data corresponding to the registered user which may include but not limited to health history, insurance information, doctors, list of hospitals, emergency reason, address and contact information and the like.

Further as shown in FIG. 1c, an emergency/medical health record managing unit 122 included in the application platform 114 configured to instantly track the medical record of the registered user for providing a comprehensive view of the tracked record in emergency. The tracked medical record may include but not limited to health conditions, medication for health conditions, medical allergies, other allergies, preferred emergency hospital, languages spoken, blood group and the like. The tracked data is notified to the selected emergency aid services providers and the corresponding personal care aid by a notification or alerting unit 124. The notification or alerts are transmitted based on proximity, capability and availability of multiple emergency aid service providers which may include but not limited to ambulance service providers, hospitals, emergency services, doctors, insurance companies, blood banks, traffic police/traffic management and other organ transplant/donation banks/authority through various communication protocols such as short message service, web service, chat protocol, internet relay chat protocol, remote method invocation protocol, location based service and the like. Also the notification and alerting unit 124 notifies the disaster management authorities using triggers based on geo density of emergencies, density of the type of emergency invoked, spurt in call volume, spurt in specific diseases and the like.

Also further as shown in FIG. 1c, the application platform includes an instant messaging unit 126 configured to instantly communicate with the multiple emergency aid service providers for receiving plurality of opinions related to the queries requested by the registered user. Also a local data repository unit 128 included in the application platform 114 used to store the personal care aids provided by the registered user, set of emergency aid services, medical record of the users and habits of the personal care aids corresponding to the registered user.

Also as shown in FIG. 1c, the remote data repository unit 104a is in communication with multiple personal care aids 108a and 108b through a data communication network. Each individual personal care aid may be a father, brother, or any other caregiver provided by the corresponding emergency user is updated with the medical record or health condition of the user. The multiple personal care aids 108a and 108b provided by the user are interlinked with each other and also with the selected emergency aid service provider 106a, 106b, 106c and 106d to exchange data among themselves.

FIG. 1D is a diagram 100d illustrating another exemplary system for sharing data between multiple emergency aid service providers and personal care aids. According to a non limiting exemplary embodiment of the present disclosure, the system including a remote data repository unit 104a used to remotely store the personalized data related to the users registered with the application platform, personal care aids provided by the each individual user, notification and alerts transmitted and received from the emergency aid service providers and list of emergencies provided by the application platform.

Further as shown in FIG. 1d, the remote data repository unit 104a is in communication with multiple emergency aid service providers 106a, 106b, 106c and 106d through a data communication network. Also that each emergency aid service provider 106a, 106b, 106c and 106d are interlinked with one another to share the data received by any one of the emergency aid service provider 106a, 106b, 106c and 106d. For example, the user invokes in selecting an emergency service provider 106a referred as a hospital. The complete health records and current geographical location of the registered user is dynamically transmitted to the invoked emergency service provider 106a. Thus, the user in charge of shifting from one emergency service provider 106a to other emergency service provider 106b may directly communicate with each other to share the data corresponding to the person in emergency between them.

FIG. 1e is a diagram 100e illustrating an example exemplary system for sharing data between multiple emergency aid service providers. According to a non limiting exemplary embodiment of the present disclosure, the emergency/medical health record management unit 122 as mentioned in FIG. 1c transmits the recorded data to multiple emergency aid service providers 106a, 106b, 106d, 106e, 106f, 106g, 106h, 106i, 106j, 106k, 106l, 106m and similar patients 106c. As shown in FIG. 1d, the emergency aid service providers may include but not limited to emergency provider 106a, other health care professionals 106b, doctors 106d, diagnostic 106f, pharmacy 106g, hospitals/clinics 106h, blood bank 106i, disaster management 106j, non-governmental organizations 106k, insurance 106l, pharmaceuticals 106m and the like.

As shown in FIG. 1e, in some embodiments, for example, the user in emergency in need of a diagnostic lab 106f receives a request from the doctor/patient/personal care aid about the nature of test in prior of reaching the respective diagnostic lab 106f. The generated test results can be uploaded and notified to the respective user and the doctor simultaneously after completion of tests and also the diagnostic provider can initiate requests to pickup sample from patients home. Also the diagnostics are enabled with reminder service for diagnostic tests around chronic illnesses. In some embodiments, pharmacy 106g can also receive the request from patient/personal care aid for medicines based on the prescription provided by the doctor. This will allow the pharmacy 106g to put together all medicines in advance and reduce the waiting time for the patient and/or also enable the pharmacy to accept home delivery requests through the system and provide a reminder service for medications around chronic illnesses.

Further as shown in FIG. 1e, in some embodiments, blood bank 106i also receives a request form a patient/personal care aid/doctor to provide the availability of blood and demand for blood by the group. The demanded blood group available in the respective blood bank 106i is immediately transferred to the respective hospital/clinic of the patient. In some embodiments, doctor 106d receives a request from a patient/personal care aid to schedule an appointment and get ready for the treatment by arranging required medical approach by collecting the data from the emergency/medical health record management unit 122. In some other embodiments, other health care professionals 106b such as dentist, surgeons, pedodentists are also enabled to receive a request from a patient/personal care aid/doctors to visit the patient in emergency and/or schedules an appointment with the respective health care professional 106b for the special treatment. Also in some embodiments, school/company 106e may receive a request from the patient/personal care aid/doctor to provide the previous health records of the patient being part of a company or a school.

Also further as shown in FIG. 1e, in some embodiments, patients 106c of similar health problem also receives a request from a patient/personal care aid/doctor to have an interaction and know the solutions of concerned treatment or usage of treatment and/or also build a mental ability in continuing with the treatment or to know the result of the treatment suggested by the respective doctor. In some other embodiments, the hospitals/clinics 106h receives a request from a patient/personal care aid/doctor to transfer the complete data of the patient in changing the hospital/clinic with the concern of doctor or by own. In some other embodiments, disaster management 106j is also enabled to receive a request form patient/personal care aid to immediately visit the place and provide respective measures to help the people in need. Also, in some embodiments, nongovernmental organizations 106k also receives a request from the patients/volunteers to reach the place immediately and help the people in need by shifting to hospitals/clinics.

Moreover as shown in FIG. 1e, in some embodiments, the insurance company 106l interacted with patient to claim insurance also receives a request from a patient/personal care aid to provide a financial help in the treatment of the patient. In some embodiments, the pharmaceuticals 106l receives a request from the doctor/other emergency providers to manufacture the drug unavailable for treatment. Further the emergency medical records provided by the user are accessed by the emergency aid service provider 106a and also the emergency aid service provider or the emergency user is allowed to enter or upload the further health records provided by the present emergency aid service provider 106a which may include but not limited to scanned health records, prescriptions, diagnostic reports and the like. Also the emergency aid service providers can publish the services provided by them such as bed availability, scanning facilities, blood bank and the like information useful for the emergency responders which may include 108 services, and other health services.

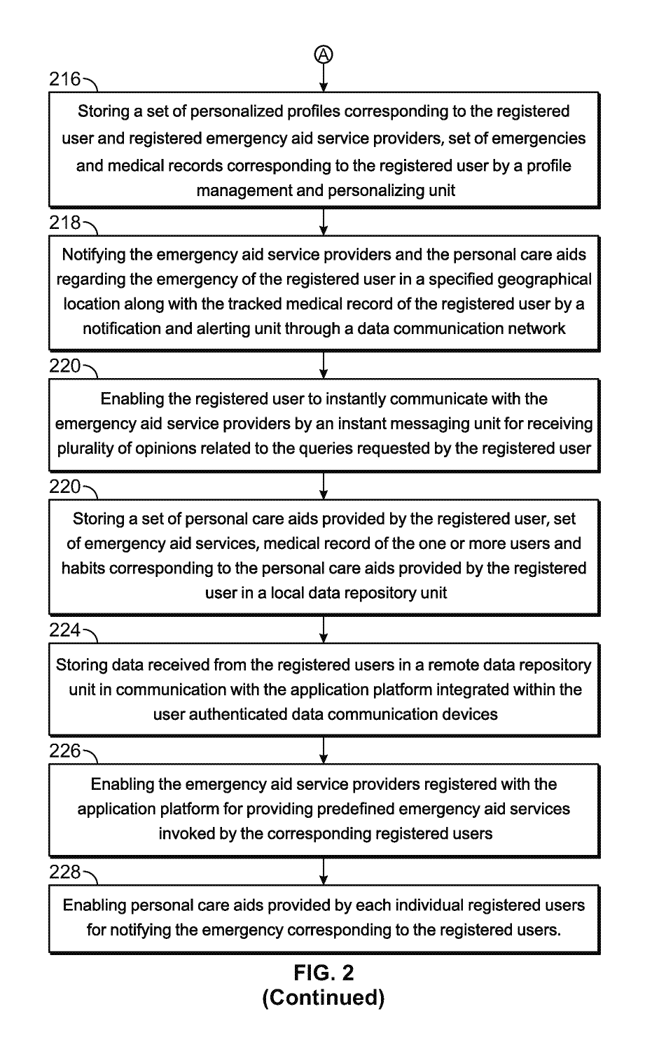

FIG. 2 is a flow diagram 200 illustrating a method for providing an emergency aid service. According to a non limiting exemplary embodiment of the present disclosure, the method of providing emergency aid services starts at 202 by enabling multiple users to register with an application platform downloaded in the authenticated data communication devices corresponding to the registered users. Next at 204, the registered users are provided with a unique identification code for communicating in emergency to receive predefined emergency aid services from the multiple emergency aid service providers.

As shown in FIG. 2, at step 206, an application platform integrated within the registered user data communication device is triggered by a triggering unit to access the corresponding application platform for communicating with multiple emergency aid service providers and the personal care aid. Next at 208, an emergency selecting unit included in the application platform configured to select an emergency from a predetermined list of emergencies provided by the application platform. At step 210, a current geographical location of the registered user is dynamically tracked by a location tracking unit and transmit the tracked data to selected emergency aid service provider based on the emergency invoked by the registered user and the personal care aid at 212. Further at 214, an emergency medical record managing unit configured to instantly track a medical record corresponding to the registered user for providing a comprehensive view of the tracked record in emergency corresponding to the registered user.

Also as shown in FIG. 2, at 216 a set of personalized profiles corresponding to the registered user, a set of personalized profiles corresponding to the registered emergency aid service providers, a set of emergencies and medical records corresponding to the registered user are stored in a profile management and personalizing unit. Next at 218, the emergency aid service providers and the one or more personal care aids are notified regarding the emergency of the registered user in a specified geographical location along with the tracked emergency medical record of the registered user by a notification and alerting unit through a data communication network. Further at 220, the registered users are also enabled to instantly communicate with the emergency aid service providers by an instant messaging unit for receiving plurality of opinions related to the queries requested by the registered user. The set of personal care aids provided by the registered user, set of emergency aid services, medical record of the one or more users by the corresponding personal care aids provided by the registered user are stored in a local data repository unit at 222.

Further as shown in FIG. 2, at 224 the data received from the registered users is stored in a remote data repository unit in communication with the application platform integrated within the user authenticated data communication devices. Next at 226, the emergency aid service providers registered with the application platform are enabled for providing predefined emergency aid services invoked by the corresponding registered emergency aid service provider by a registered user. Further at 228, the personal care aids provided by each individual registered users are enabled for notifying the emergency corresponding to the registered one or more users.

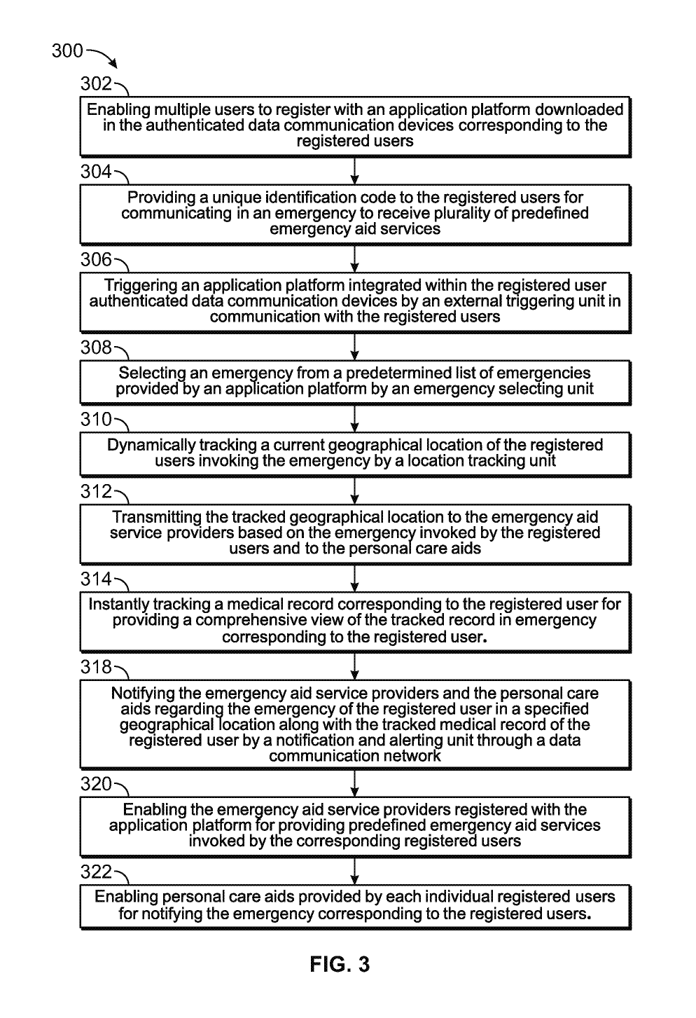

FIG. 3 is a flow diagram 300 illustrating a method of invoking an emergency aid service provider by a registered user. According to a non limiting exemplary embodiment of the present disclosure, the method of invoking an emergency service provider starts at step 302 by enabling multiple users to register with an application platform downloaded in the authenticated data communication devices corresponding to the registered users. Next at step 304, the registered users are provided with a unique identification code for communicating in emergency to receive predefined emergency aid services from the multiple emergency aid service providers.

As shown in FIG. 3, at step 306, an application platform integrated within the registered user data communication device is triggered by a triggering unit to access the corresponding application platform for communicating with multiple emergency aid service providers and the personal care aid. Next at 308, an emergency selecting unit included in the application platform configured to select an emergency from a predetermined list of emergencies provided by the application platform. At step 310, a current geographical location of the registered user is dynamically tracked by a location tracking unit and transmit the tracked data to selected emergency aid service provider based on the emergency invoked by the registered user and the personal care aid at 312. Further at 314, an emergency medical record managing unit configured to instantly track a medical record corresponding to the registered user for providing a comprehensive view of the tracked record in emergency corresponding to the registered user.

Further as shown in FIG. 3, at step 316 an emergency aid service providers and multiple personal care aids are notified regarding the emergency of the registered user in a specified geographical location along with the tracked medical record of the registered user by a notification and alerting unit through a data communication network. Next at 318 the emergency aid service providers registered with the application platform are enabled to receive the notification provided by the registered user for providing predefined emergency aid services invoked by the corresponding registered users. Further at 320 the personal care aids provided by the each individual registered user is enabled for notifying the emergency corresponding to the registered users.

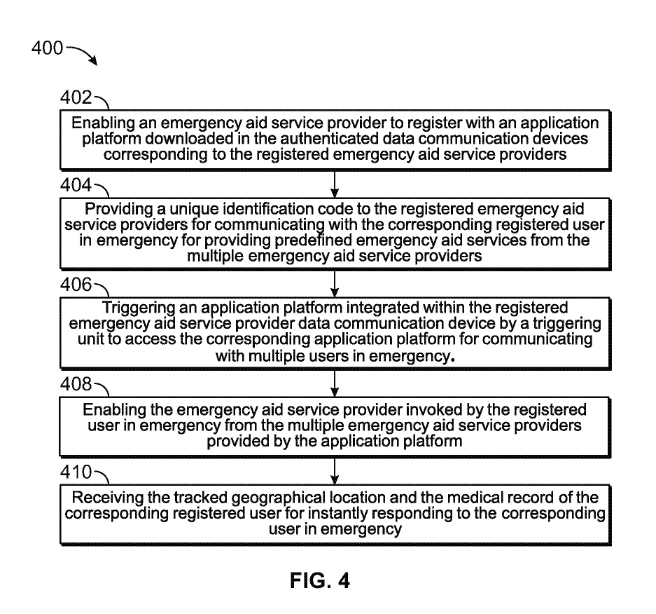

FIG. 4 is a flow diagram 400 illustrating a method for enabling emergency aid service provider to communicate with the registered user. According to a non limiting exemplary embodiment of the present disclosure, the method of communicating with the registered user in emergency starts at step 402 by enabling an emergency aid service provider to register with an application platform downloaded in the authenticated data communication devices corresponding to the registered emergency aid service providers. Next at 404 the registered emergency aid service providers are provided with a unique identification code for communicating with the corresponding registered user in emergency for providing predefined emergency aid services from the multiple emergency aid service providers.

As shown in FIG. 4, at step 406 an application platform integrated within the registered emergency aid service provider data communication device is triggered by a triggering unit to access the corresponding application platform for communicating with multiple users in emergency. Next at 408, the emergency aid service provider invoked by the registered user is enabled to receive the tracked geographical location and the medical record of the corresponding registered user for instantly responding to the corresponding user in emergency at 410.

Although the present invention has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present invention is defined by the appended claims and includes both combinations and sub combinations of the various features described herein above as well as variations and modifications thereof, which would occur to persons skilled in the art upon reading the foregoing description.

1. A computer program product for providing an emergency aid service, the computer program product comprising:
an emergency selecting unit configured to select at least one emergency from a predetermined list of emergencies, whereby the emergency selecting unit configured to be invoked by a registered user in an emergency; and one or more personal care aids of the registered users;
a location tracking unit configured to dynamically track a current geographical location of the registered users invoking the emergency, whereby the tracked geographical location transmitted to the one or more emergency aid service providers based on the emergency invoked by the registered users; and to the one or more personal care aids;
an emergency medical record managing unit configured to instantly track medical record corresponding to the registered user for providing a comprehensive view of the record in any emergency, whereby the tracked data transmitted to the one or more emergency aid service providers; and the one or more personal care aids;
a profile management and personalizing unit configured to store a set of personalized profiles corresponding to the registered user; a set of personalized profiles corresponding to the registered emergency aid service providers; a set of emergencies; and medical records corresponding to the registered user;
notification and alerting unit configured to notify the one or more emergency aid service providers; and the one or more personal care aids regarding the emergency of the registered user in a specified geographical location along with the tracked medical record of the registered user through a data communication network;
an instant messaging unit configured for enabling the registered user to instantly communicate with the one or more emergency aid service providers for receiving plurality of opinions related to the queries requested by the registered user; and
a local data repository unit configured to store set of personal care aids provided by the registered user; set of emergency aid services; medical record of the one or more users;
and habits of the personal care aids corresponding to the registered user.

2. A system for providing an emergency aid service, the system comprising:
one or more users registered with a unique identification code configured to communicate in an emergency for receiving plurality of predefined emergency aid services;
an external triggering unit in communication with the one or more registered users configured to trigger an application platform integrated within the one or more registered users, whereby the application platform comprising:
an emergency selecting unit configured to select at least one emergency from a predetermined list of emergencies, whereby the emergency selecting unit configured to be invoked by a registered user in an emergency; and one or more personal care aids of the registered users;
a location tracking unit configured to dynamically track a current geographical location of the registered users invoking the emergency, whereby the tracked geographical location transmitted to the one or more emergency aid service providers based on the emergency invoked by the registered users; and to the one or more personal care aids;
an emergency medical record managing unit configured to instantly track medical record corresponding to the registered user for providing a comprehensive view of the record in any emergency, whereby the tracked data transmitted to the one or more emergency aid service providers; and the one or more personal care aids;
a profile management and personalizing unit configured to store a set of personalized profiles corresponding to the registered user; a set of personalized profiles corresponding to the registered emergency aid service providers; a set of emergencies; and medical records corresponding to the registered user;
notification and alerting unit configured to notify the one or more emergency aid service providers; and the one or more personal care aids regarding the emergency of the registered user in a specified geographical location along with the tracked medical record of the registered user through a data communication network;
an instant messaging unit configured for enabling the registered user to instantly communicate with the one or more emergency aid service providers for receiving plurality of opinions related to the queries requested by the registered user; and
a local data repository unit configured to store set of personal care aids provided by the registered user; set of emergency aid services; medical record of the one or more users; and habits corresponding to the personal care aids of the registered user;
a remote data repository unit in communication with the application platform integrated within one or more user data communication devices corresponding to the one or more users configured to store the data received from the one or more registered users;
one or more emergency aid service providers registered with the application platform enabled by the registered one or more users for providing predefined services required by the corresponding registered one or more users; and
one or more personal care aids provided by the each individual registered one or more users enabled for notifying the emergency corresponding to the registered one or more users.

3. The system of claim 2, wherein the one or more emergency aid service providers configured to share the data received by at least one of the one or more emergency aid service provider.

4. The system of claim 2, wherein at least one of emergency aid service provider enabled from the set of one or more emergency aid service providers for accessing the medical records corresponding to the registered user.

5. The system of claim 2, wherein an anonymous empathy built between one or more registered users corresponding to the similar issues.

6. The system of claim 2, wherein the registered one or more users enabled to seek an appointment from respective one or more emergency aid service providers; and receive real time notifications for efficient management of time.

7. The system of claim 2, wherein the one or more emergency aid service providers configured to schedule appointments in advance and reduce interruptions in the busy schedule.

8. The system of claim 2, wherein the one or more emergency aid service providers configured to create an online profile; and unique uniform resource locator for providing an enhanced a unique network.

9. The system of claim 2, wherein the one or more emergency service providers also used to promote services; offers; and member subscriptions.

10. A method for providing an emergency aid service, the method comprising:
providing a unique identification code to one or more registered users for communicating in an emergency to receive plurality of predefined emergency aid services;
dynamically triggering an application platform integrated within the one or more registered user authenticated data communication devices by an external triggering unit in communication with the one or more registered users, whereby the application platform comprising:
selecting an at least one emergency from a predetermined list of emergencies by an emergency selecting unit, whereby the emergency selecting unit configured to be invoked by a registered user in an emergency; and one or more personal care aids of the registered users;
dynamically tracking a current geographical location of the registered users invoking the emergency by a location tracking unit, whereby the tracked geographical location transmitted to the one or more emergency aid service providers based on the emergency invoked by the registered users; and to the one or more personal care aids;
instantly tracking a medical record corresponding to the registered user by an emergency medical record managing unit for providing a comprehensive view of the record in any emergency, whereby the tracked data transmitted to the one or more emergency aid service providers; and the one or more personal care aids;
storing a set of personalized profiles corresponding to the registered user; a set of personalized profiles corresponding to the registered emergency aid service providers; a set of emergencies; and medical records corresponding to the registered user by a profile management and personalizing unit;
notifying one or more emergency aid service providers; and one or more personal care aids regarding the emergency of the registered user in a specified geographical location along with the tracked medical record of the registered user by a notification and alerting unit through a data communication network;
enabling the registered user to instantly communicate with the one or more emergency aid service providers by an instant messaging unit for receiving plurality of opinions related to the queries requested by the registered user; and
storing a set of personal care aids provided by the registered user; set of emergency aid services; medical record of the one or more users; and habits corresponding to the personal care aids provided by the registered user in a local data repository unit.
storing data received from one or more registered users in a remote data repository unit in communication with the application platform integrated within the one or more user authenticated data communication devices;
enabling one or more emergency aid service providers registered with the application platform for providing predefined emergency aid services invoked by the corresponding registered one or more users; and
enabling one or more personal care aids provided by each individual registered one or more users for notifying the emergency corresponding to the registered one or more users.
